(19) United States
(12) Patent Application Publication
(10) Pub. No.: US 2026/0180649 A1
(43) Pub. Date: Jun. 25, 2026

(54) WAKE-UP RECEIVER-BASED CHANNEL STATE FEEDBACK

(71) Applicant: QUALCOMM Incorporated, San Diego, CA (US)

(72) Inventors: Hemant SAGGAR, San Diego, CA (US); Igor GUTMAN, Hod HaSharon (IL); Tao LUO, San Diego, CA (US); Prashant SHARMA, San Marcos, CA (US)

(21) Appl. No.: 18/989,768

(22) Filed: Dec. 20, 2024

(51) Int. Cl. H04B 7/06; H04B 17/318; H04W 52/02

(52) U.S. Cl. CPC H04B 7/0626; H04B 17/328; H04W 52/0229

(57) ABSTRACT

Certain aspects of the present disclosure provide techniques for channel state feedback via a wake-up receiver. An example method includes obtaining a first configuration that indicates to send a first channel state information (CSI) report based on a first set of parameters associated with a first receiver; obtaining a second configuration that indicates to send a second CSI report based on a second set of parameters associated with a second receiver that includes a wake-up receiver; obtaining first signaling; and sending the second CSI report based on one or more first measurements of the first signaling.

### INTRODUCTION

### Field of the Disclosure

Aspects of the present disclosure relate to wireless communications, and more particularly, to techniques for channel state feedback via a wake-up receiver.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a first configuration that indicates to send a first CSI report based on a first set of parameters associated with a first receiver; obtaining a second configuration that indicates to send a second CSI report based on a second set of parameters associated with a second receiver that includes a wake-up receiver; obtaining first signaling; and sending the second CSI report based on one or more first measurements of the first signaling.

Certain aspects provide a method for wireless communications by a network node. The method includes sending a first configuration that indicates to send a first CSI report based on a first set of parameters associated with a first receiver; sending a second configuration that indicates to send a second CSI report based on a second set of parameters associated with a second receiver that includes a wake-up receiver; sending first signaling; and obtaining the second CSI report based on one or more first measurements of the first signaling.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 depicts an example of a discontinuous reception configuration.

FIG. 7 depicts an example scheme for channel state feedback via a wake-up receiver.

FIG. 8 depicts an example of reporting wake-up receiver-based channel state information with a periodicity.

FIG. 9 depicts a process flow for channel state feedback via a wake-up receiver.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for wake-up receiver-based channel state feedback.

Certain wireless communication systems (e.g., a 5G New Radio (NR) system or any future system) may implement various power saving techniques, such as discontinuous reception (DRX). Under DRX, a user equipment (UE) may periodically wake up from a low power state to monitor for certain signaling (such as downlink control information) from a network node (e.g., a base station). In certain cases, a UE may be equipped with a main radio (e.g., a transceiver) and a low power, low-complexity receiver, which may be referred to as a wake-up receiver (WUR). During a DRX cycle, the UE may monitor for a wake-up signal, using the WUR, to determine whether to wake-up the main radio, which may remain turned off or in a sleep state unless turned on via the wake-up signal. The WUR may be used to monitor for the wake-up signal with ultra-low power consumption, whereas the main radio may be used for data transmission and/or reception operations that use higher power consumption compared to the WUR. In some examples, the main radio may be referred to as a main receiver. Furthermore, the WUR may be part of a transceiver capable of transmission and reception of radio frequency (RF) signals.

In certain cases, the wake-up signal may be based on a waveform that enables the WUR to be a low power, low complexity receiver. Such a wake-up signal may be referred to as a low-power wake-up signal (LP-WUS). As an example, the wake-up signal may be modulated using an on-off keying (OOK) scheme or frequency shift keying (FSK) scheme instead of a higher-order modulation scheme, such as quadrature phase shift keying (QPSK), which may be used for a physical downlink control channel (PDCCH).

In certain cases, the WUR may be used for other power saving operations, such as time-frequency synchronization and/or radio resource management (RRM). As an example, when a UE is in a low power state (e.g., idle mode or a DRX), the UE may monitor a low-power synchronization signal (LP-SS) or a synchronization signal block (SSB), using the WUR, for time-frequency synchronization with a network node. In certain cases, the UE may monitor (e.g., measure) the LP-SSs or SSB associated with a serving cell and/or a neighbor cell for RRM. As an example, the UE may monitor the LP-SS or SSB, using the WUR, to detect radio link failure with a serving cell or to detect a candidate cell for handover.

In certain cases, closed-loop feedback associated with a communication channel (e.g., channel state feedback) may be used to dynamically adapt communication parameters (e.g., modulation and coding scheme, beamforming, multiple-input and multiple-output (MIMO) layers, or the like) according to time varying channel conditions, for example, due to changes with respect to UE mobility, weather conditions, scattering, fading, interference, noise, or the like. As an example, a UE may monitor certain reference signals transmitted by a network node and report channel state information (CSI) associated with the reference signals to the network node, which may adjust certain communication parameters in response to the CSI from the UE.

Technical problems for channel state feedback may include, for example, effective power consumption and/or usage of computational resources to communicate channel state feedback. In certain cases, the UE may be configured to monitor certain reference signals (e.g., SSBs and/or CSI reference signals (CSI-RSs)) via the main radio and report the CSI periodically to a network node. The periodic channel state feedback may enable effective wireless communications between a UE and a network node, for example, in terms beam management, radio link management, UE mobility management, and/or the like. As an example, under DRX, the UE may be configured to monitor CSI-RS transmissions every five milliseconds (ms) and report the CSI every DRX cycle, for example, every 160 ms. Accordingly, the UE may consume a non-trivial amount of power to receive reference signals via the main radio, generate the CSI, and report the CSI.

In certain cases, a CSI report may include various information associated with the communication channel, such as a channel quality indicator (CQI), a precoding matrix indicator (PMI) (e.g., precoding feedback), a layer indicator (LI), a rank indicator (RI), a reference signal received power (RSRP), a signal-to-noise ratio (SNR), a signal-to-interference plus noise ratio (SINR), and/or the like. The CSI report may include CSI associated with multiple reference signals, beams, frequency bandwidths (e.g., wideband information and/or subband information), MIMO layers, or the like. The CSI report may be generated using a certain level of computational resources, for example, in terms of digital signal processing capabilities (e.g., fast Fourier transform precision, quantization granularity in terms of bit width or size of parameters, oversampling, analog-to-digital converter (ADC) sampling rates, or the like). Accordingly, a UE may use a non-trivial amount of computational resources to generate a CSI report.

Aspects described herein may overcome the aforementioned technical problem(s), for example, by providing channel state feedback derived from a WUR, which may enable reduced power consumption and/or reduced usage of computational resources at a UE. In certain aspects, the UE may be configured to monitor certain reference signals and report CSI with certain specifications that enable the UE to use the WUR for signal reception and processing. As an example, the specifications associated with WUR-based CSI may be relaxed relative to CSI derived from a main radio. The terms “WUR-based CSI” or “WUR-based channel state feedback” may refer to CSI derived from a WUR, for example, via signal reception and quantization. The WUR-based CSI may include content that complies with the capabilities of the WUR, such as receiver sensitivity, filtering (e.g., interference or noise cancellation), frequency bandwidth, down-conversion, ADC sampling rate, ADC bitwidth, and/or the like. With respect to CSI derived from a main radio, the specifications associated with WUR-based CSI may support a reduced number of ranks, a reduced set of CQI values, a reduced frequency granularity (for example, for precoding feedback), WUR-specific codebook(s) for precoding feedback, a reduced number of CSI-RS ports, a reduced number of beams, and/or a relaxed quantization granularity, for example, as further described herein. In certain aspects, the reporting frequency and/or monitoring frequency may be adjusted for WUR-based CSI. As an example, when the WUR is enabled for channel state feedback, the UE may increase the periodicity associated with reference signal monitoring and/or reporting CSI.

Certain techniques for WUR-based channel state feedback described herein may provide various beneficial technical effects and/or advantages. The techniques for channel state feedback may enable improved wireless communications performance, such as reduced power consumption, reduced usage of computational resources, and/or the like. As the WUR-based CSI may have relaxed specifications (e.g., reduced CQIs or ranks, simpler codebooks, and/or the like), the UE may be capable of processing the CSI using reduced computational resources, for example, in terms of digital signal processing specifications, such as processing latency, memory usage, sampling rate, bit width, or the like. As an example, the UE may perform digital signal processing operations with a reduced sampling rate and/or relaxed fast Fourier transform (FFT) specifications (e.g., reduced FFT size and/or FFT resolution). Accordingly, the reduced sampling rate and/or FFT specifications may in turn reduce the memory usage and/or processing complexity (e.g., processing latency) associated with generating CSI based on received signaling measurements.

In certain cases, the reduced power consumption and/or reduced usage of computational resources may be attributable to the WUR-based CSI that enables a UE to monitor channel conditions using a low-complexity, low-power receiver, such as a WUR. As an example, the UE may use a reduced amount of power to monitor reference signals using the WUR for channel state feedback.

In certain cases, the reduced power consumption may be attributable to an increased periodicity used to monitor reference signals and/or report CSI when a WUR is enabled for channel state feedback. As an example, when the main radio is used for channel state feedback, the UE may monitor reference signals more frequently than when the WUR is enabled for channel state feedback. Accordingly, the UE may use a reduced amount of power to monitor reference signals due to the increased periodicity associated with monitoring the reference signals.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

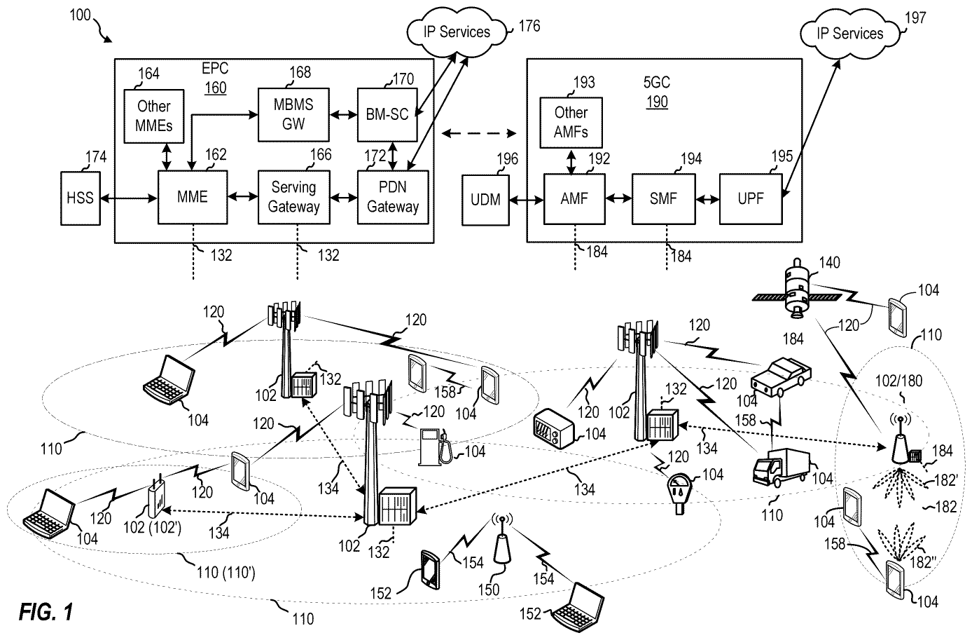

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In certain aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

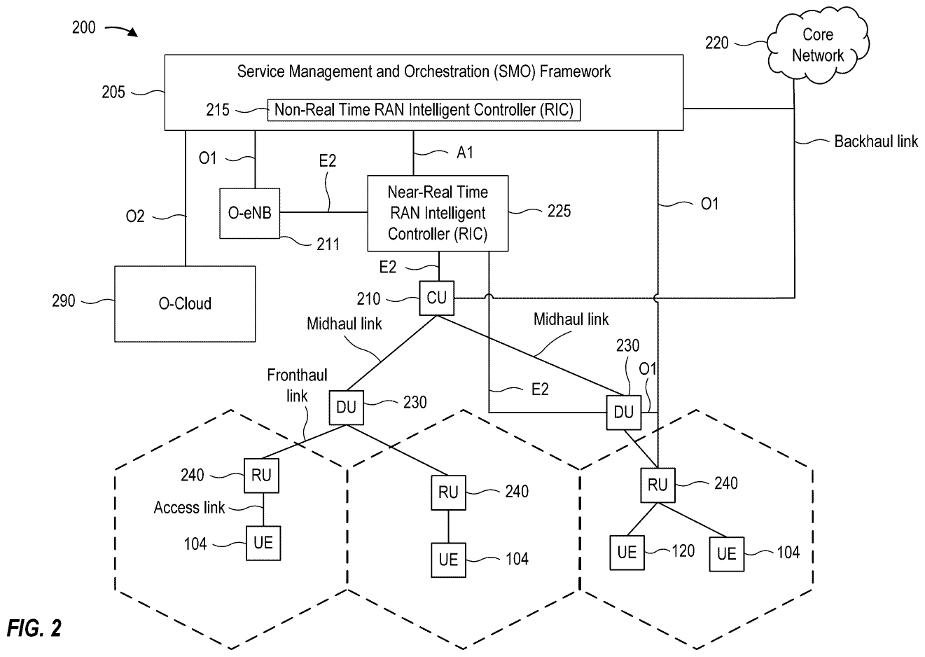

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In certain aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In certain aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like. Certain UEs 104 implement power-saving technology such as a WUR.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In certain aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In certain aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In certain aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

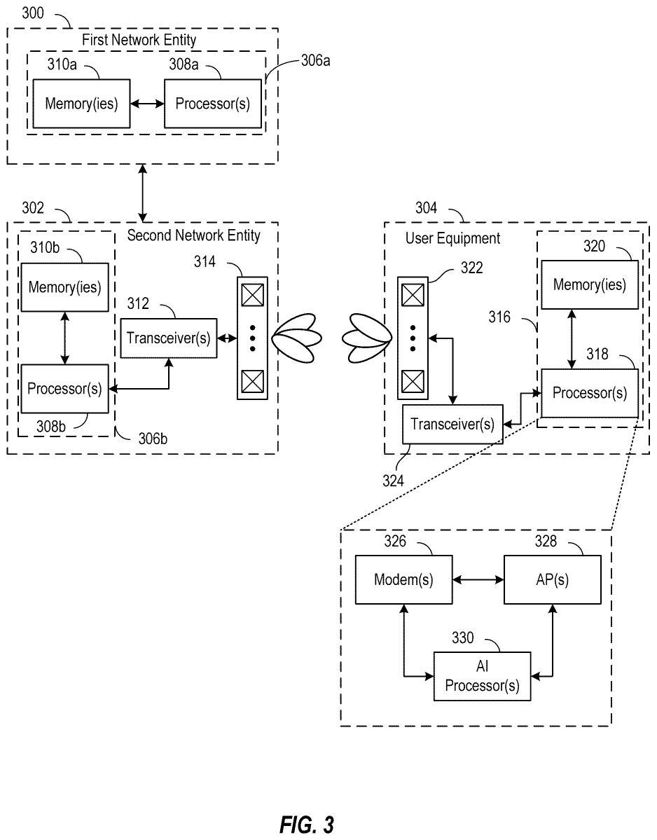

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In certain aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In certain aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

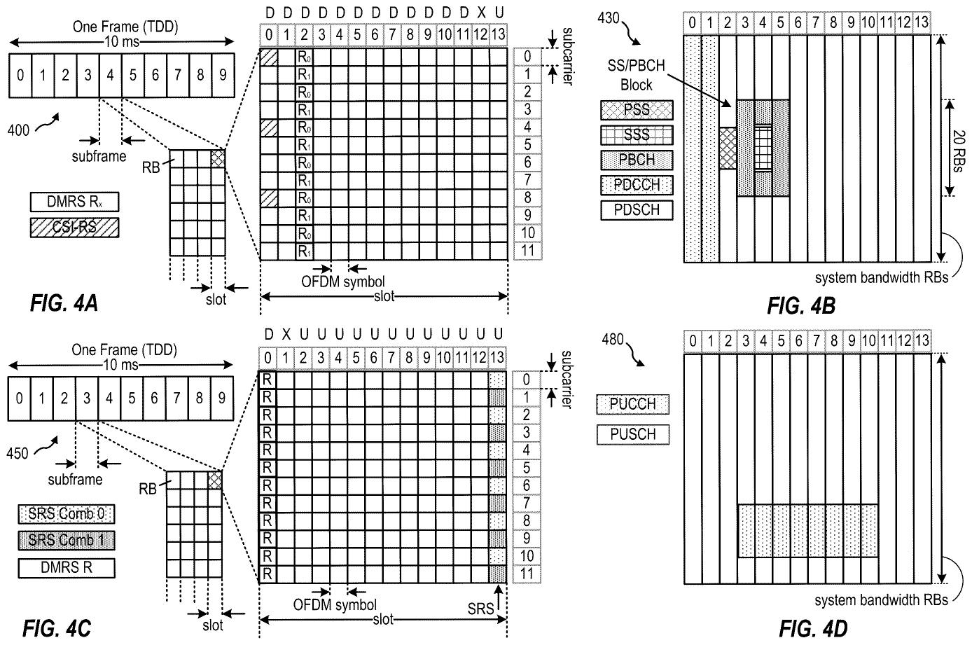

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communication systems, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., SSB, CSI-RS, DMRS, PT-RS, etc.) from a network entity (or another UE) and report channel state feedback to the network entity (or the other UE), where the channel state feedback is determined based on measurements of the reference signal received at the UE.

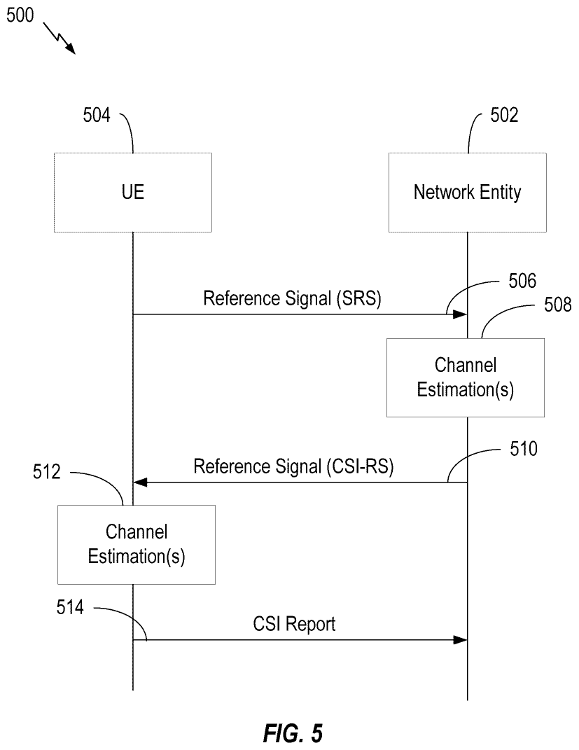

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In certain aspects, the UE 504 may send the reference signal (e.g. SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs channel calculations based on the reference signal, such as determining a channel estimate H based on the received reference signal, for example, as further described herein with respect to the UE performing channel calculations at 512. In certain aspects, the network entity 502 may further calculate, as part of the channel calculations, a precoder (e.g., precoder matrix) V based on the channel estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In certain aspects, the network entity may send the reference signal with precoding (e.g., beamforming, MIMO layer(s), and/or compensation for signal propagation effects) based on the channel estimate and/or precoder determined at 508.

At 512, the UE 504 performs channel calculations based on the reference signal, such as determining a channel estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector y that is a representation of the received reference signal as received over each of the multiple antennas of the UE 504.

Based on a received signal model, the vector y can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 502 over a number of spatial layers, and \vec{n} is noise across the communications channel. In certain aspects, H has a size equal to the number of antennas used to receive the signaling, Nant, times the number of spatial layers, Nₗ, (e.g., the number of beamformed transmissions, number of antenna ports, etc.). For example, H has a number of rows equal to Nₐₙₜ and a number of columns equal to Nₗ. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 514, UE 504 sends to the network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using a modulation scheme, code rate, number of MIMO layers, or the like, that the network entity determines based on the CSI report.

### Example Discontinuous Reception Cycle

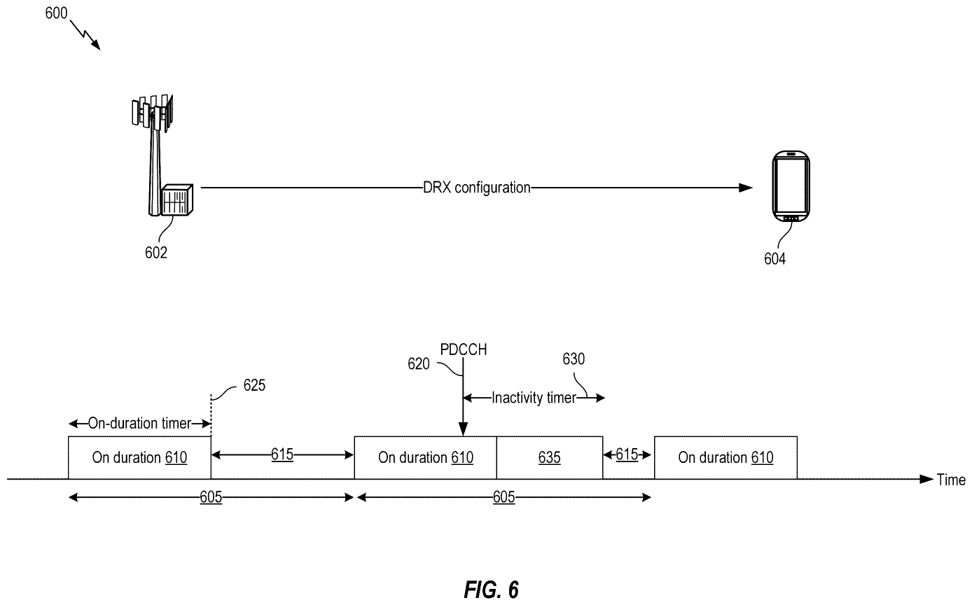

FIG. 6 depicts an example 600 of a DRX configuration. As shown, a network entity 602 may transmit, and a UE 604 may receive, a DRX configuration. The network entity 602 may be an example of the BS 102 of FIG. 1, the first network entity 300 or the second network entity 302 of FIG. 3, or a disaggregated base station as discussed with respect to FIG. 2. The UE 604 may be an example of the UE 104 of FIG. 1 or UE 304 of FIG. 3. The DRX configuration may be communicated via RRC signaling, MAC signaling, DCI, system information, and/or the like.

The DRX configuration may configure a DRX cycle 605. A DRX cycle 605 may include a DRX on duration 610 (for example, during which a UE 604 is awake or in an active state) and an opportunity to enter a DRX sleep state 615. The time during which the UE 604 is configured to be in an active state during the DRX on duration 610 plus any extension of the DRX on duration 610 (for example, due to an inactivity timer) may be referred to as an active time period of the DRX cycle 605. The time during which the UE 604 is configured to be in the DRX sleep state 615 may be referred to as an inactive time period (or a DRX off duration) of the DRX cycle 605. The UE 604 may monitor a downlink control channel (for example, a PDCCH) during the active time period, and the UE 604 may refrain from monitoring the downlink control channel during the inactive time period. In certain cases, the UE 604 may enter a lower power state during the inactive time period. Thus, the DRX cycle 605 may enable power savings at the UE 604, for example, due to periodic monitoring of the downlink control channel.

During the DRX on duration 610, the UE 604 may monitor a control channel, such as the PDCCH. For example, the UE 604 may monitor the control channel for control information (for example, DCI) pertaining to the UE 604. If the UE 604 does not detect and/or successfully decode any control channel communications addressed to the UE 604 during the DRX on duration 610, then the UE 604 may enter the sleep state 615 (for example, for the inactive time period) at the end 625 of the DRX on duration 610. In this way, the UE 604 may conserve battery power and/or reduce power consumption. As shown, the DRX cycle 605 may repeat with a configured periodicity according to the DRX configuration.

If the UE 604 detects and/or successfully decodes a control channel communication 620 addressed to the UE 604, then the UE 604 may remain in an active state (for example, awake) for the duration of a DRX inactivity timer 630 (for example, which may extend into the configured inactive time period of the current DRX cycle). The DRX inactivity timer 630 may be referred to herein as a timer parameter. The time period 635 depicts the extension of the active time period due to the DRX inactivity timer 630 being initiated. The UE 604 may start the DRX inactivity timer 630 at a time at which the control channel communication is received (for example, in a transmission-time-interval in which the control channel communication 620 is received, such as symbol, a slot, or a subframe). The UE 604 may remain in the active state until the DRX inactivity timer 630 expires, at which time the UE 604 may enter the sleep state 615 (for example, for the remainder of the inactive time period of the current DRX cycle). During the duration of the DRX inactivity timer 630, the UE 604 may continue to monitor for control channel communications, may obtain a downlink data communication (for example, on a data channel such as a PDSCH) scheduled by the control channel communication, and/or may prepare and/or transmit a communication (for example, on a PUSCH and/or a PSSCH) scheduled by the control channel communication. The UE 604 may restart the DRX inactivity timer 630 after each detection of a control channel communication for the UE 604 for an initial transmission (for example, but not, in some cases, for a retransmission). By operating in this manner, the UE 604 may conserve battery power and/or reduce power consumption by entering the sleep state 615.

### Aspects Related to WUR-Based Channel State Feedback

Aspects of the present disclosure provide various schemes associated with WUR-based channel state feedback, which may enable reduced power consumption and/or reduced usage of computational resources at a UE.

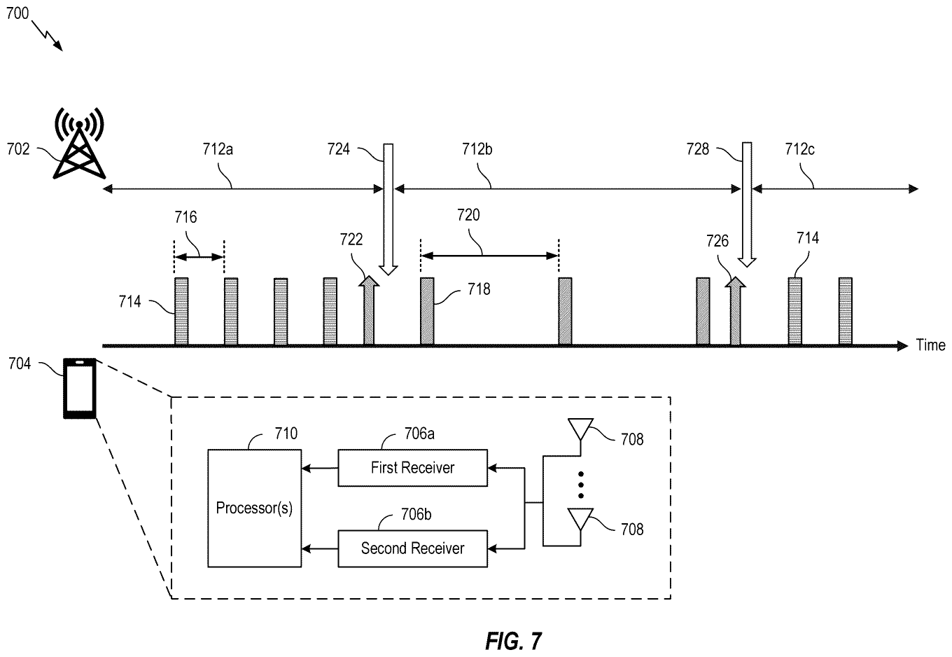

FIG. 7 depicts an example scheme 700 for channel state feedback, which may be derived from a WUR. In this example, a UE 704 may be configured to monitor reference signal transmissions from a network node 702 and report CSI (such as WUR-based CSI) to the network node 702. The UE 704 may be an example of the UE 104, 304, 504 of FIGS. 1-3 and 5, respectively. The network node 702 may be an example of the BS 102 of FIG. 1, a disaggregated base station of FIG. 2, the first network entity 300 or the second network entity 302 of FIG. 3, and/or the network entity 502 of FIG. 5.

The UE 704 may include a first receiver 706a and a second receiver 706b. The first receiver 706a and the second receiver 706b may be coupled between a set of antennas 708 (e.g., the antenna 322 of FIG. 3) and one or more processors (hereinafter “the processor 710”). The processor 710 may be an example of the one or more processors 318 of FIG. 3 or the processing system 316 of FIG. 3.

Each of the first receiver 706a and the second receiver 706b may be configured to feed signal(s) received via at least one antenna of the set of antennas 708 to the processor 710. The first receiver 706a may be different from the second receiver 706b. As an example, the first receiver 706a may be or include (part of) a main radio (MR), which may be or include a transceiver (e.g., the one or more transceivers 324 of FIG. 3); whereas the second receiver 706b may be a low power, low complexity receiver, such as a WUR. In certain cases, the second receiver 706b may be part of a transceiver, such as the one or more transceivers 324 of FIG. 3. Accordingly, the second receiver 706b may be capable of consuming less power to receive signaling compared to the first receiver 706a.

In certain aspects, the first receiver 706a may be configured to receive signaling modulated at higher-order modulation schemes (e.g., QPSK, QAM, or the like) compared to the modulation order supported by the second receiver 706b (e.g., OOK, FSK, or the like). The first receiver 706a may be configured to receive signaling modulated in multiple sub-carriers (for example, according to OFDM), and the first receiver 706a may support a greater number of sub-carriers compared to a multi-carrier or single-carrier modulation scheme (e.g., OOK and/or FSK) supported by the second receiver 706b. The first receiver 706a may be capable of receiving signaling with a wider frequency bandwidth and/or a wider range of frequency bandwidths (e.g., 20 MHz to 2,000 MHz) compared to the second receiver 706b, which may only support one or two frequency bandwidths of 20 MHz or less (e.g., 5 MHz or 20 MHz). In certain cases, the second receiver 706b may be capable of receiving signaling only in FR1, whereas the first receiver 706a may be capable of receiving signaling in FR1, FR2, and/or other frequency ranges.

In certain cases, the second receiver 706b may be capable of converting analog signals to digital samples with a smaller bit width and/or lower sampling rate compared to the first receiver 706a. For signals received via the second receiver 706b, the processor 710 may perform certain processing operations (e.g., digital signal processing) with certain specifications (e.g., memory usage, processing latency, bit width, sampling rate, FFT size, FFT frequency resolution, or the like) that may be different from the specifications associated with signals received via the first receiver 706a. As an example, the processor 710 may perform digital signal processing operations with reduced memory usage, an increased processing latency, a reduced bit width, a reduced sampling rate, a reduced FFT size, an increased FFT frequency resolution, and/or the like. Accordingly, the CSI derived from the second receiver 706b (e.g., WUR-based CSI) may be generated with reduced power consumption and/or reduced usage of computational resources relative to CSI derived from the first receiver 706a.

In certain aspects, the UE 704 may be configured to report, to the network node 702, CSI derived from the first receiver 706a and/or the second receiver 706b. As an example, the UE 704 may obtain a first configuration that indicates to send a first CSI report based on a first set of parameters associated with the first receiver 706a. The UE 704 may obtain a second configuration that indicates to send a second CSI report based on a second set of parameters associated with the second receiver 706b. In certain cases, the second set of parameters may be relaxed compared to the first set of parameters, for example, due to the different capabilities between the first receiver 706a and the second receiver 706b. The first set of parameters may comply with certain capabilities of the first receiver 706a, and the second set of parameters may comply with certain capabilities of the second receiver 706b.

As an example, during a first time period 712a, the UE 704 may obtain first signaling (not shown) from the network node 702 and send, to the network node 702, one or more first CSI reports 714 according to the first configuration. The UE may receive the first signaling (e.g., one or more reference signals) via the first receiver 706a. In certain cases, the first signaling may be formed in compliance with the capabilities of the first receiver 706a, for example, in terms of the carrier frequency, subcarrier spacing, frequency bandwidth, modulation scheme, and/or the like. The first signaling may be an example of the reference signal(s) transmitted by the network entity 502 of FIG. 5. The first CSI report(s) 714 may include information based on one or more measurements of the first signaling. In certain cases, the UE 704 may send the first CSI report(s) 714 with a first periodicity (e.g., 20 ms to 160 ms).

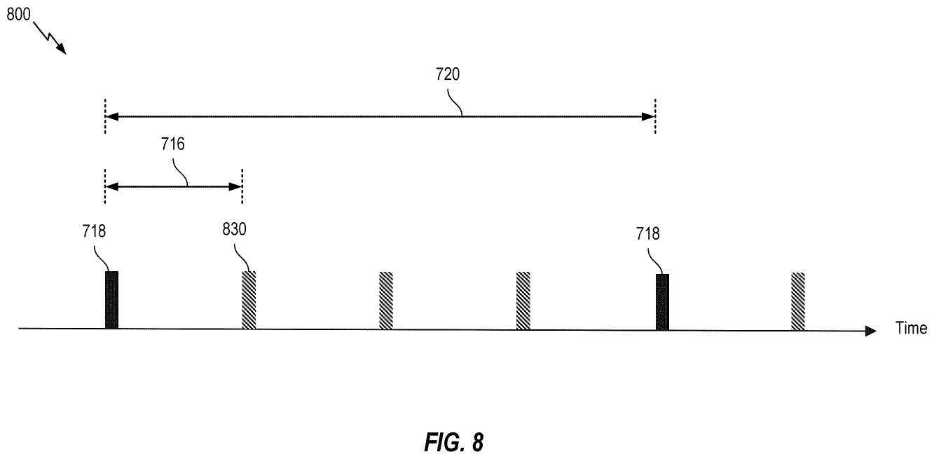

During a second time period 712b, the UE 704 may obtain second signaling (not shown) from the network node 702 and send, to the network node 702, one or more second CSI reports 718 according to the second configuration. The UE 704 may receive the second signaling (e.g., one or more reference signals) via the second receiver 706b, which may enable the UE 704 to reduce its power consumption used to monitor reference signals and/or report CSI to the network node 702. In certain aspects, the second set of parameters may indicate or include an indication of the second signaling to monitor for the WUR-based CSI, which may be an example of the relaxed specifications associated with the second set of parameters. The second signaling may include one or more reference signals, such as CSI-RS, synchronization signal (e.g., LP-SS), and/or a tracking reference signal (TRS). The second CSI report(s) 718 may include information based on one or more measurements of the second signaling. In certain cases, the second signaling may be formed in compliance with the capabilities of the second receiver, for example, in terms of the carrier frequency, subcarrier spacing, frequency bandwidth, modulation scheme, and/or the like. As an example, the second signaling may occupy a frequency bandwidth that is less than a bandwidth of the first signaling. The second signaling may have a frequency bandwidth of 20 MHz or less; whereas the first signaling may have larger frequency bandwidth (e.g., 20 MHz to 2,000 MHz). In certain cases, the UE 704 may send the second CSI report(s) 718 with a second periodicity 720 (e.g., 160 ms), which may be different from the first periodicity 716. The different periodicity may be an example of the relaxation of the second set of parameters with respect to the first set of parameters. The second periodicity 720 may have a longer duration (or be increased) relative to the first periodicity 716, for example, as described herein with respect to FIG. 8. The second periodicity 720 may be based on the first periodicity 716. The longer duration of the second periodicity 720 may enable the UE 704 to reduce its power consumption used to monitor reference signals and/or report CSI to the network node 702.

In certain cases, the UE 704 may send, to the network node 702, a request 722 to switch to the second receiver 706b for CSI measurement or for usage of relaxed CSI parameter(s), for example, the second set of parameters. As an example, the UE 704 may communicate with the network node 702 in a connected state (e.g., RRC connected mode or state) during the first time period 712a. Then, during the second time period 712b, the UE 704 may communicate with the network node 702 in a low power state (e.g., RRC idle mode or RRC inactive mode). Before (or after) transitioning to the low power state, the UE 704 may send a request (e.g., the request 722) to enable the second configuration and/or for usage of the second set of parameters. In certain cases, the UE 704 may request to switch from aperiodic CSI reports (e.g., per the first configuration) to semi-persistent or periodic CSI reports (e.g., per the second configuration). The semi-persistent or periodic CSI reports may be an example of the relaxed second set of parameters. Sending an aperiodic CSI report may involve consuming a non-trivial amount of power, for example, due to an aperiodic CSI report being sent via a PUSCH resource, which may involve employing the first receiver to receive an uplink grant and may trigger an inactivity timer to monitor the PDCCH (for as long as ˜100 ms) during a DRX cyle. Thus, the UE 704 may request to switch to semi-persistent or periodic CSI reporting. As the semi-persistent and periodic CSI reporting may not use an aperiodic resource, an aperiodic resource may be skipped if the CSI report falls within a DRX inactive time. In certain cases, the network node 702 may send, to the UE 704, an indication to switch to reporting WUR-based CSI. For example, the network node 702 may send, to the UE 704, an indication 724 to activate the second configuration and/or deactivate the first configuration, for example, in response to the request 722.

During a third time period 712c, the UE 704 may obtain the first signaling (not shown) from the network node 702 and send, to the network node 702, the first CSI reports 714 according to the first configuration, for example, as described herein with respect to the first time period 712a. In certain cases, the UE 704 may send, to the network node 702, a request 726 to switch to the first receiver 706a for CSI measurement. The request 726 may indicate to enable the first configuration and/or for usage of the first set of parameters. In certain cases, the network node 702 may send, to the UE 704, an indication 728 to deactivate the second configuration and/or activate the first configuration, for example, in response to the request 726.

In certain aspects, the UE 704 may be configured with certain criteria that trigger activation and/or deactivation of the second configuration. As an example, certain entry condition(s) may trigger the UE 704 to activate the second configuration, and certain exit condition(s) may trigger the UE 704 to deactivate the second configuration. In certain cases, the entry condition(s) and/or exit condition(s) may be associated with activation or deactivation of the second receiver 706b to perform certain power saving operation(s), such as wake-up signal (e.g., LP-WUS) monitoring associated with a DRX cycle, time-frequency synchronization (e.g., via a LP-SS or SSB), RRM, and/or the like. Thus, configuration of the entry condition(s) and/or exit condition(s) for certain power saving operation(s) may implicitly indicate to apply the entry condition(s) and/or exit condition(s) to WUR-based CSI (e.g., per the second configuration). In certain cases, the second configuration may be activated when the entry condition(s) are satisfied, and/or when the exit condition(s) are not satisfied. In certain cases, the second configuration may be activated when the second receiver 706b (e.g., a WUR) is enabled according to the entry condition(s), and the second configuration may be deactivated when the second receiver 706b is disabled according to the exit condition(s).

The entry condition(s) and/or exit condition(s) may be or include (a) if an SSB (or any other suitable reference signal) based measurement on the first receiver 706a satisfies a threshold and/or (b) if an LP-SS (or any other suitable reference signal) based measurement on the second receiver 706b satisfies a threshold. As an example, for idle mode, the entry condition may be triggered if an SSB based measurement on the first receiver 706a satisfies a first threshold, and the exit condition may be triggered if an LP-SS based measurement on the second receiver 706b satisfies a second threshold. The thresholds for entry and exit conditions may be different and/or depend on the capability of the UE 704. In certain cases, the UE 704 may send certain UE assistance information associated with entry and/or exit condition(s) to allow the network node 702 to determine entry and/or exit condition(s) for the UE 704.

In certain aspects, the second set of parameters may be, indicate, or include certain quantities reported in the second CSI report(s) 718. Relaxation of the second set of parameters with respect to the first set of parameters may be in relation to the capabilities of the second receiver 706b, for example, in terms of frequency bandwidth, interference mitigation, sampling rate, and/or the like. The second set of parameters may have specification(s) that comply with the capabilities of the second receiver 706b, and thus, the second set of parameters may be relaxed with respect to the first set of parameters. In certain aspects, the second set of parameters may include relaxed specifications for MIMO layer feedback (e.g., the RI). As an example, the second set of parameters may include a RI that is associated with a set of ranks having a total number of ranks less than a rank total of the first set of parameters. As another example, the second set of parameters may include a RI that is associated with a first maximum possible number of layers being less than a second maximum possible number of layers associated with the first set of parameters. The second set of parameters may indicate that a reduced set of RI values may be indicated in the second CSI report 718. In certain cases, the second receiver 706b may support a certain number of MIMO layers, such as a single MIMO layer. Accordingly, the second set of parameters may indicate that there is only one RI value (e.g., Rank-1 associated with a single MIMO layer) available to report in the second CSI report 718. The second set of parameters may include a RI that only indicates a single layer.

In certain aspects, the second set of parameters may include relaxed CQI specifications. A CQI may indicate a certain modulation and coding scheme (MCS) (e.g., QPSK rate 1/2, 16 QAM rate 1/3, 16 QAM rate 1/2, 16 QAM rate 3/4, 64 QAM rate 1/2, etc.) supported on a communication link, for example, between a UE and a network node. The second set of parameters may include a CQI that is associated with a set of indexes having a total number of indexes less than an index total of the first set of parameters. For example, the second set of parameters may include a reduced set of CQI values within CQI table(s) and/or fewer CQI tables or CQI tables(s) specific to the second receiver 706b. The second set of parameters may include a frequency granularity that is different from a frequency granularity of the first set of parameters. The second set of parameters may include a CQI that is associated with a set of indexes having a single index per modulation order (e.g., QPSK rate 1/2, 16QAM rate 1/2, 64QAM rate 1/2, etc.) among a plurality of modulation orders. As an example, the second set of parameters may indicate that there are only four CQI indexes available to be reported. In certain cases, the second set of parameters may indicate that a subset of CQI indexes associated with the first set of parameters may be used to indicate the CQI for the second CSI report.

Table 1 provides an example CQI index table, where each of the CQI indexes is associated with a modulation scheme, a code rate, and a spectral efficiency. In this example, any row with an “X” in the WUR column indicates the respective CQI index is part of the second set of parameters. In certain cases, a separate table of CQI indexes for the second set of parameters may include the row(s) marked with “X” in the WUR column of Table 1.

TABLE 1
Example CQI Index Table

| | | | | |
|---|---|---|---|---|
| | CQI | | Code | Spectral |
| WUR | index | Modulation | rate × 1024 | Efficiency |

| | | |
|---|---|---|
| X | 0 | Out of range |

| | | | | |
|---|---|---|---|---|
| X | 1 | QPSK | 78 | 0.1523 |
| | 2 | QPSK | 120 | 0.2344 |
| | 3 | QPSK | 193 | 0.3770 |
| | 4 | QPSK | 308 | 0.6016 |
| | 5 | QPSK | 449 | 0.8770 |
| | 6 | QPSK | 602 | 1.1758 |
| X | 7 | 16QAM | 378 | 1.4766 |
| | 8 | 16QAM | 490 | 1.9141 |
| | 9 | 16QAM | 616 | 2.4063 |
| | 10 | 64QAM | 466 | 2.7305 |
| X | 11 | 64QAM | 567 | 3.3223 |
| | 12 | 64QAM | 666 | 3.9023 |
| | 13 | 64QAM | 772 | 4.5234 |
| | 14 | 64QAM | 873 | 5.1152 |
| | 15 | 64QAM | 948 | 5.5547 |

Table 2 provides another example CQI index table, where each of the CQI indexes is associated with a modulation scheme, a code rate, and a spectral efficiency. In this example, any row with an “X” in the WUR column indicates the respective CQI index is part of the second set of parameters. In certain cases, a separate table of CQI indexes for the second set of parameters may include the row(s) marked with “X” in the WUR column of Table 2.

TABLE 2
Example CQI Index Table

| | | | | |
|---|---|---|---|---|
| | CQI | | Code | Spectral |
| WUR | index | Modulation | rate × 1024 | Efficiency |

| | | |
|---|---|---|
| X | 0 | Out of range |

| | | | | |
|---|---|---|---|---|
| X | 1 | QPSK | 78 | 0.1523 |
| | 2 | QPSK | 193 | 0.3770 |
| | 3 | QPSK | 449 | 0.8770 |
| X | 4 | 16QAM | 378 | 1.4766 |
| | 5 | 16QAM | 490 | 1.9141 |
| | 6 | 16QAM | 616 | 2.4063 |
| X | 7 | 64QAM | 466 | 2.7305 |
| | 8 | 64QAM | 567 | 3.3223 |
| | 9 | 64QAM | 666 | 3.9023 |
| | 10 | 64QAM | 772 | 4.5234 |
| | 11 | 64QAM | 873 | 5.1152 |
| X | 12 | 256QAM | 711 | 5.5547 |
| | 13 | 256QAM | 797 | 6.2266 |
| | 14 | 256QAM | 885 | 6.9141 |
| | 15 | 256QAM | 948 | 7.4063 |

In certain aspects, the second set of parameters may include relaxed precoding feedback specifications. The second set of parameters may include a PMI that is associated with a set of codebooks having a total number of codebooks less than a codebook total of the first set of parameters. For example, the second set of parameters may have reduced precoding feedback options, such as one or two codebooks associated with precoding feedback. The second set of parameters may include certain precoding matrices that comply with the capabilities of the second receiver 706b. As an example, the second set of parameters may indicate that there is only a Type-I single panel codebook with up to two ranks for MIMO layers used for precoding feedback. As another example, the second set of parameters may indicate that there is either a Type-I single panel codebook or a Type-I multi-panel codebook with up to two ranks for MIMO layers used for precoding feedback. In certain cases, the second set of parameters may indicate that a subset of PMIs associated with the first set of parameters may be used to indicate the PMI for the second CSI report.

In certain aspects, the second set of parameters may include relaxed oversampling specifications associated with the precoding feedback. The second set of parameters may include an oversampling factor that is different from an oversampling factor of the first set of parameters. The oversampling factor may be associated with the precoding feedback, such as oversampling of beams in azimuth and/or elevation direction(s). Oversampling of beams in a direction may provide more precise beam control at the cost of higher computational complexity (e.g., in terms of memory usage, processing latencies, or the like). The second set of parameters may have reduced oversampling of beams per direction (e.g., azimuth and/or elevation) in PMI reporting (e.g., precoding feedback). In certain aspects, the second set of parameters may indicate that there is no oversampling of beams associated with precoding feedback.

In certain aspects, the second set of parameters may include relaxed CSI-RS port specifications. The second set of parameters may include a set of CSI-RS ports having a total number of ports that is less than a port total of the first set of parameters. The second set of parameters may indicate there is a reduced number of CSI-RS ports measured and/or reported with respect to the second CSI report. For example, the first set of parameters may indicate that up to 32 CSI-RS ports may be used to measure reference signal(s), whereas the second set of parameters may indicate that a subset of the 32 CSI-RS ports may be used to measure reference signal(s). In certain aspects, the UE 704 and the network node 702 may agree on which CSI-RS port(s) to use to measure the CSI. As an example, the UE 704 may request a subset of CSI-RS ports to be used for the second configuration, and the network node 702 may send the second configuration with the subset of CSI-RS ports. In certain aspects, the UE 704 may indicate which CSI-RS port(s) that the UE 704 uses for WUR-based CSI, for example, in the second CSI-RS port.

Table 3 provides an example of the total number of CSI-RS antenna ports and corresponding specifications (e.g., antenna configuration(s) and oversampling factor(s)) associated with WUR-based CSI and/or CSI derived from a MR. In certain cases, the second set of parameters may indicate that a total of four and/or eight CSI-RS ports may be used to measure reference signal(s) for WUR-based CSI. As an example, for four CSI-RS ports, the second set of parameters may indicate the corresponding antenna configuration (e.g., a 2×1 linear array of antenna elements with cross-polarization) and oversampling factors. As the WUR-based CSI may support up to eight CSI-RS ports, there may be no corresponding oversampling factors for more CSI-RS ports (e.g., >8 CSI-RS ports) as indicated by “N/A” meaning not applicable.

TABLE 3
Example Number of CSI-RS ports, Antenna
Configurations, and Oversampling Factors

| Number of | Antenna | Oversampling | Oversampling |
|---|---|---|---|
| CSI-RS antenna | configuration | factors for MR | factors for |
| ports, P_{CSI-RS} | (N₁, N₂) | (O₁, O₂) | WUR (O₁, O₂) |
| 4 | (2, 1) | (4, 1) | (1, 1) |
| 8 | (2, 2) | (4, 4) | (1, 1) |
| | (4, 1) | (4, 1) | (1, 1) |
| 12 | (3, 2) | (4, 4) | N/A |
| | (6, 1) | (4, 1) | N/A |
| 16 | (4, 2) | (4, 4) | N/A |
| | (8, 1) | (4, 1) | N/A |
| 24 | (4, 3) | (4, 4) | N/A |
| | (6, 2) | (4, 4) | N/A |
| | (12, 1) | (4, 1) | N/A |
| 32 | (4, 4) | (4, 4) | N/A |
| | (8, 2) | (4, 4) | N/A |
| | (16, 1) | (4, 1) | N/A |

In certain aspects, the second set of parameters may include relaxed beam specifications. The second set of parameters may include a set of beams having a total number of beams less than a beam total of the first set of parameters. In certain aspects, the second receiver 706b may not be able to measure all of the configured or active beams (e.g., associated with CSI-RSs and/or SSBs) due to memory usage and/or beam-switch latency specifications. Accordingly, the second set of parameters may indicate that a reduced number of beams are reported for the second CSI report.

In certain aspects, the second set of parameters may include relaxed specifications for quantization granularity of certain measurement(s). The second set of parameters may include a metric having a first quantization granularity that is greater than a second quantization granularity of the first set of parameters. The metric may include a received signal strength (e.g., RSRP) and/or a received signal quality (e.g., SINR or SNR). A quantization granularity may refer to a unit size of a quantization, such as a unit size associated with a bit used to represent a metric, such as (Layer-1) RSRP, SNR, and/or SINR. The second set of parameters may indicate that the quantization granularity associated with the metric (e.g., RSRP, SNR, and/or SINR) may be larger than the first set of parameters. As an example, the quantization granularity associated with the second set of parameters may have a bit step size of ±5 dB compared to a step size of ±2 dB for the first set of parameters.

In certain aspects, the second set of parameters may include relaxed frequency granularity specifications. The second set of parameters may have a different frequency granularity (or bandwidth) than the first set of parameters, for example, due to the capabilities of the second receiver 706b and/or processor 710 (for example, in terms of receiver bandwidth, quantization sampling rate, FFT frequency resolution, FFT size, and/or the like). In certain cases, the second receiver 706b may be capable of receiving signals with a certain frequency bandwidth (e.g., 5 MHz or 20 MHz) as described herein. Thus, the reference signal for WUR-based CSI computation may be transmitted with a certain frequency bandwidth (e.g., 5 MHz or 20 MHz), different than the frequency bandwidth of the reference signal for CSI computation by the main radio. The frequency bandwidth of the reference signal for WUR-based CSI computation may overlap with or be the same as a low-power wake-up signal (LP-WUS). The second set of parameters may include an indication to report certain CSI (e.g., precoding feedback or information) with only one of a wideband frequency granularity (e.g., precoding feedback with wideband information) or a subband frequency granularity (e.g., precoding feedback with subband information). As an example, the wideband and/or subband frequency granularity may have a size of 5 MHz or 20 MHz. In certain cases, the second set of parameters may include an indication to report certain CSI (e.g., precoding feedback or information) with a wideband frequency granularity and a single-subband frequency granularity. In certain cases, the second receiver 706b may be capable of processing a single subband at a time. Thus, the second set of parameters may indicate to report a single subband or to obtain more measurements (e.g., CSI-RS samples) at different measurement occasions to generate a CSI report with multiple subbands. In certain cases, the UE 704 may receive the reference signal(s) in certain subband(s) for extrapolation or estimation of CSI associated with a wideband frequency bandwidth or other subband(s). The reference signals may be transmitted by the network entity 702 across the wideband frequency bandwidth or the measured subband(s).

In certain aspects, the UE 704 and the network node 702 may exchange signaling to determine which parameter(s) to use for the second set of parameters. As an example, the UE 704 may send, to the network node 702, an indication of preferred parameter(s) for WUR-based CSI. The network node 702 may send, to the UE 704, the second configuration, which may be based on the preferred parameter(s), and then, the UE 704 may send, to the network node 702, an acknowledgement of the second set of parameters. In certain cases, the UE 704 may send, to the network node 702, an indication to start or stop WUR-based CSI.

In certain aspects, the second configuration may indicate to report WUR-based CSI only outside an active time associated with a DRX cycle (e.g., a connected mode DRX (C-DRX) cycle). In certain aspects, the second configuration may indicate to report WUR-based CSI outside and within the activate time associated with a DRX cycle.

In certain aspects, the second configuration may indicate to report WUR-based CSI during a DRX cycle (e.g., a C-DRX cycle and/or an idle mode DRX (I-DRX) cycle). For example, the second set of parameters may apply to C-DRX and/or I-DRX modes.

In certain aspects, the second configuration may apply to only the second receiver 706b (e.g., WUR-based CSI). As an example, the UE 704 may only receive the second signaling via the second receiver 706b.

In certain aspects, the second configuration may apply to CSI derived from the first receiver or the second receiver. As an example, when the first receiver wake-up is sparse, the UE 704 may apply the second configuration to reporting CSI derived from the first receiver. With respect to FIG. 7, the UE 704 may receive the second signaling via the first receiver and report the second CSI report(s) according to the second configuration.

In certain aspects, the second configuration may apply to the second receiver and optionally, the first receiver. For example, the UE 704 may send, to the network node 702, an indication of whether the CSI is derived from the first receiver 706a or the second receiver 706b. With respect to FIG. 7, the UE 704 may send, to the network node 702, an indication that reception of the second signaling was via the first receiver 706a and/or the second receiver 706b.

In certain aspects, the second configuration may be communicated via RRC signaling, MAC signaling (e.g., a MAC control element), DCI, system information, and/or the like. The second configuration may be updated, activated (e.g., started), and/or deactivated (e.g., stopped), for example, via RRC signaling, MAC signaling, DCI, system information, and/or the like. The second configuration may be sent before or along with an indication to activate or deactivate the second configuration.

FIG. 8 depicts an example of reporting WUR-based CSI with a periodicity. In this example, a UE (such as the UE 704) may obtain the first configuration and the second configuration as described herein with respect to FIG. 7. The first configuration may indicate to report the first CSI report(s) periodically or semi-persistently with the first periodicity 716. The second configuration may indicate to report the second CSI report(s) 718 periodically or semi-persistently with the second periodicity 720, which may be based on the first periodicity 716. For example, the second configuration may indicate for the UE to send the second CSI report 718 every nth CSI reporting occasion 830 (e.g., the nth instance of the first CSI report with the first periodicity) associated with the first configuration, where n may be configured as an integer value (such as n=1, 2, 4, or the like). Thus, the second configuration may be relaxed relative to the first configuration. The duration of the second periodicity 720 may be equal to n instances of the first periodicity 716. With respect to FIG. 8, n may be equal to 4. The longer duration of the second periodicity 720 may enable the UE to obtain additional samples of the reference signals for multi-subband reporting, improved accuracy, and/or energy savings.

In certain aspects, the periodicity relaxation for reporting WUR-based CSI may apply only to reports sent outside of an active time period of a DRX cycle, for example, as described herein with respect to FIG. 6. In certain cases, determining the nth instance of the first CSI report may exclude or include any instances of the first CSI report that occur in the active time period, for example, when (at a time at which) the first receiver 706a may be activated.

### Example Signaling of WUR-Based Channel State Feedback

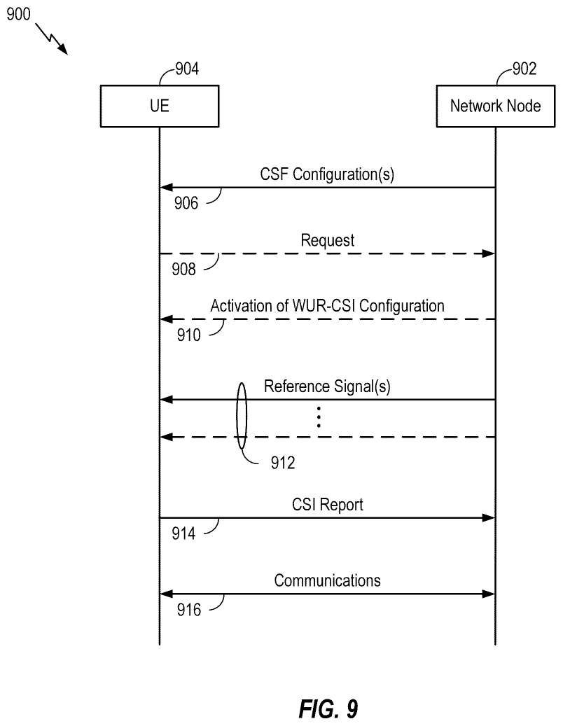

FIG. 9 depicts a process flow 900 for communication of WUR-based channel state feedback in a system between a network node 902 and a UE 904. In certain aspects, the network node 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. In certain cases, the UE 904 may be an example of the UE 704 of FIG. 7. For example, the UE 904 may include a first receiver (e.g., a receiver of a main radio) and/or a second receiver (e.g., a WUR) as described herein with respect to FIG. 7. However, in other aspects, UE 904 may be another type of wireless communications device, and the network node 902 may be another type of network entity or network node, such as those described herein. Note that any operations or signaling illustrated with dashed lines may indicate that that operation or signaling is an optional or alternative example.

At 906, the UE 904 obtains, from the network node 902, one or more configurations associated with channel state feedback (CSF). The configuration(s) may indicate to report WUR-based CSI based on certain parameter(s), such as the second set of parameters described herein with respect to FIG. 7. As an example, the configuration(s) may include the first configuration and/or the second configuration as described herein with respect to FIG. 7. The configuration(s) may be communicated via RRC signaling, MAC signaling, DCI, system information, and/or the like.

At 908, the UE 904 optionally sends, to the network node 902, a request to activate the second configuration associated with WUR-based CSI. In certain cases, the request may indicate to switch to the second receiver for CSI measurement. In certain cases, the request may indicate for activation of the second configuration and/or usage of the second set of parameters. The request may be communicated via RRC signaling, MAC signaling, UCI, and/or the like.

At 910, the UE 904 optionally obtains, from the network node 902, an indication to activate a WUR-CSI configuration (e.g., the second configuration). The network node 902 may send the indication in response to the request obtained at 908. In certain cases, the configuration(s) obtained at 906 may include the indication to activate the WUR-CSI configuration. The indication may be communicated via RRC signaling, MAC signaling, DCI, system information, and/or the like.

At 912, the UE 904 obtains, from the network node 902, one or more reference signals, for example, via the second receiver, which may be or include a WUR, for example, as described herein with respect to FIG. 7. The one or more reference signals may be an example of the first signaling and/or the second signaling described herein with respect to FIG. 7. The one or more reference signals may include SSB(s), LP-SS(s), CSI-RS(s), DMRS(s), TRS(s), and/or the like. The reference signal(s) may have certain properties (e.g., bandwidth, modulation scheme, multi-carrier, single-carrier, or the like) that enable the UE to receive the reference signal(s) via the second receiver, for example, as described herein with respect to FIG. 7. Reception of the reference signal(s) via the second receiver (e.g., the WUR) may enable the UE 904 to reduce its power consumption used to monitor reference signals and/or report CSI to the network node 902. In certain cases, the UE 904 may obtain the one or more references signals (or a portion thereof) via the first receiver in addition to or as an alternative to the second receiver.

At 914, the UE 904 sends, to the network node 902, a CSI report based on one or more measurements of the reference signal(s) received at 912. As an example, the CSI report may indicate or include a RI, CQI, precoding feedback, and/or one or more metrics associated with the reference signal(s), such as a received signal quality and/or received signal strength. The UE 904 may send the CSI report with a periodicity, for example, as described herein with respect to FIG. 8.

At 916, the UE 904 communicates with the network node 902, for example, based on the CSI report. As an example, the CSI report may enable the network node to configure various communication parameters, such as a modulation and coding scheme, MIMO layers, downlink precoding, beam selection, transmit power, or the like.

Note that the process flow illustrated in FIG. 9 is described herein to facilitate an understanding of WUR-based channel state feedback, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of WUR-Based Channel State Feedback

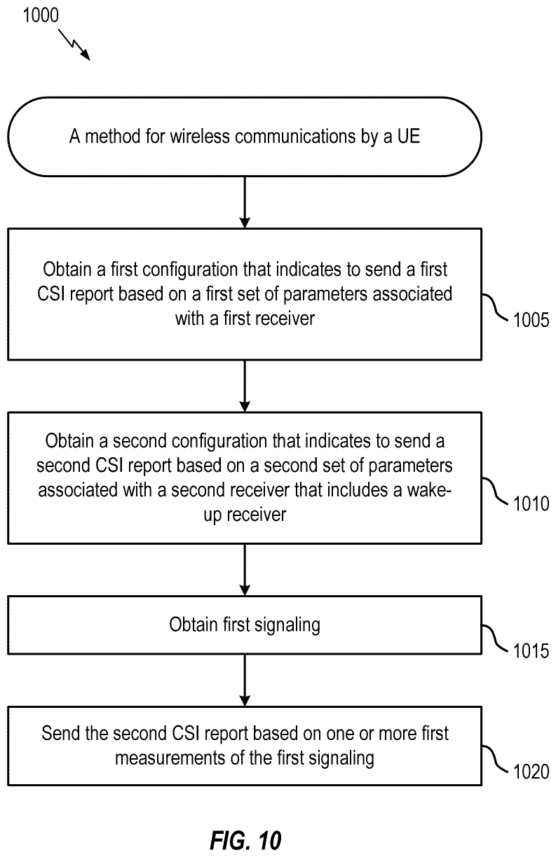

FIG. 10 shows a method 1000 for wireless communications by an apparatus, such as UE 104 of FIG. 1 or UE 304 of FIG. 3.

Method 1000 begins at block 1005 with obtaining a first configuration that indicates to send a first CSI report based on a first set of parameters associated with a first receiver, for example, as described herein with respect to FIGS. 7 and 9.

Method 1000 then proceeds to block 1010 with obtaining a second configuration that indicates to send a second CSI report based on a second set of parameters associated with a second receiver that includes a wake-up receiver, for example, as described herein with respect to FIGS. 7 and 9.

Method 1000 then proceeds to block 1015 with obtaining first signaling, for example, as described herein with respect to FIGS. 5 and 9.

Method 1000 then proceeds to block 1020 with sending the second CSI report based on one or more first measurements of the first signaling, for example, as described herein with respect to FIGS. 7-9. Thus, the apparatus sends the second CSI report (which is based on the second set of parameters associated with the second receiver) based on measurements of the first signaling. In some aspects, these measurements may be performed on the first signaling by the second receiver according to the second set of parameters. The second set of parameters may be relaxed relative to the first set of parameters, as described herein with respect to FIGS. 7-9.

In certain aspects, the second set of parameters is different from the first set of parameters. The second set of parameters may be different from the first set of parameters based on the different capabilities of the first receiver and the second receiver, for example, as described herein with respect to FIG. 7. As an example, the second set of parameters may have specification(s) that comply with the capabilities of the second receiver, whereas the first set of parameters may have other specification(s) that comply with the capabilities of the first receiver, but do not comply with the capabilities of the second receiver. In certain cases, the second set of parameters (relative to the first set of parameters) may include relaxed MIMO layer specifications, relaxed CQI specifications, relaxed precoding feedback specifications, relaxed oversampling specifications associated with the precoding feedback, relaxed CSI-RS port specifications, relaxed beam specifications, or the like.

In certain aspects, the second set of parameters includes one or more of: a rank indicator that is associated with a set of ranks having a total number of ranks less than a rank total of the first set of parameters (a rank indicator that is associated with a set of layers having a total number of layers less than a layer total of the first set of parameters); a channel quality indicator that is associated with a set of modulation and coding scheme indexes having a total number of indexes less than a modulation and coding scheme index total of the first set of parameters; a frequency granularity that is different from a frequency granularity of the first set of parameters; a precoding matrix indicator that is associated with a set of codebooks having a total number of codebooks less than a codebook total of the first set of parameters; an oversampling factor that is different from an oversampling factor of the first set of parameters; a set of CSI reference signal ports having a total number of ports that is less than a port total of the first set of parameters; a set of beams having a total number of beams less than a beam total of the first set of parameters; or a metric having a first quantization granularity that is greater than a second quantization granularity of the first set of parameters.

In certain aspects, the metric includes one or more of a received signal strength or a received signal quality.

In certain aspects, the second set of parameters includes a rank indicator that only indicates a single layer.

In certain aspects, the second set of parameters includes a channel quality indicator that is associated with a set of indexes having a single index per modulation order among a plurality of modulation orders. In certain aspects, the second set of parameters includes a channel quality indicator that is associated with a set of modulation and coding scheme indexes being a subset of indexes associated with the first set of parameters.

In certain aspects, the second set of parameters includes an indication that a single codebook is available to report precoding information. In certain aspects, the second set of parameters includes an indication that a set of codebooks is available to report precoding information, the set of codebooks being a subset of codebooks associated with the first set of parameters.

In certain aspects, the second set of parameters includes an indication to report precoding information based on a set of CSI reference signal ports having a total number of ports that is less than or equal to eight CSI reference signal ports. In certain aspects, the second set of parameters includes an indication to report precoding information based on a set of CSI reference signal ports having a total number of ports that is less than or equal to a total number of CSI reference signal ports (e.g., 32 CSI-RS ports) associated with the first set of parameters.

In certain aspects, the second set of parameters includes an indication to report precoding information with only one of a wideband frequency granularity or a subband frequency granularity.

In certain aspects, the second set of parameters includes an indication to report precoding information with a wideband frequency granularity and a single-subband frequency granularity.

In certain aspects, the second set of parameters includes an indication to report precoding information associated with a set of beams having a total number of beams less than a beam total of the first set of parameters.

In certain aspects, the first set of parameters includes an indication of a first periodicity to send the first CSI report; the second set of parameters includes an indication of a second periodicity to send the second CSI report; and the second periodicity is greater than the first periodicity.

In certain aspects, the second periodicity is based on the first periodicity.

In certain aspects, method 1000 further includes sending an acknowledgement of the second set of parameters.

In certain aspects, method 1000 further includes sending a request for usage of the second set of parameters, wherein block 1010 includes obtaining the second configuration after communication of the request.

In certain aspects, the second configuration further indicates that the second set of parameters apply outside an active time associated with a discontinuous reception cycle.

In certain aspects, the second configuration further indicates that the second set of parameters apply within the active time.

In certain aspects, the second configuration further indicates that the second set of parameters apply to a discontinuous reception cycle.

In certain aspects, method 1000 further includes obtaining second signaling.

In certain aspects, method 1000 further includes sending the first CSI report based on one or more second measurements of the second signaling, wherein the first signaling occupies a frequency bandwidth that is less than a bandwidth of the second signaling.

In certain aspects, block 1015 includes obtaining the first signaling via the second receiver.

In certain aspects, block 1015 includes obtaining the first signaling via the first receiver.

In certain aspects, method 1000 further includes sending an indication that reception of the first signaling was via the first receiver.

In certain aspects, method 1000 further includes obtaining an indication to activate the second configuration.

In certain aspects, method 1000 further includes obtaining an indication to deactivate the second configuration.

In certain aspects, the first signaling comprises one or more of a CSI reference signal, a synchronization signal, or a tracking reference signal.

In certain aspects, method 1000 further includes obtaining at least one of: an indication that activation of the second configuration depends on an entry condition being satisfied, or an indication that deactivation of the second configuration depends on an exit condition being satisfied; and obtaining second signaling, in accordance with the first configuration, based on the exit condition being satisfied; wherein obtaining the first signaling at block 1015 comprises obtaining the first signaling, in accordance with the second configuration, based on the entry condition being satisfied. In certain aspects, the entry condition is associated with first synchronization signaling; and the exit condition is associated with second synchronization signaling.

In certain aspects, method 1000 further includes obtaining an indication that activation of the second configuration depends on the second receiver being enabled. In certain aspects, method 1000 further includes obtaining an indication that deactivation of the second configuration depends on the second receiver being disabled. In certain aspects, method 1000 further includes obtaining second signaling, in accordance with the first configuration, based on the second receiver being disabled. In certain aspects, obtaining the first signaling at block 1015 comprises obtaining the first signaling, in accordance with the second configuration, based on the second receiver being enabled.

In certain aspects, the first receiver is different from the second receiver.

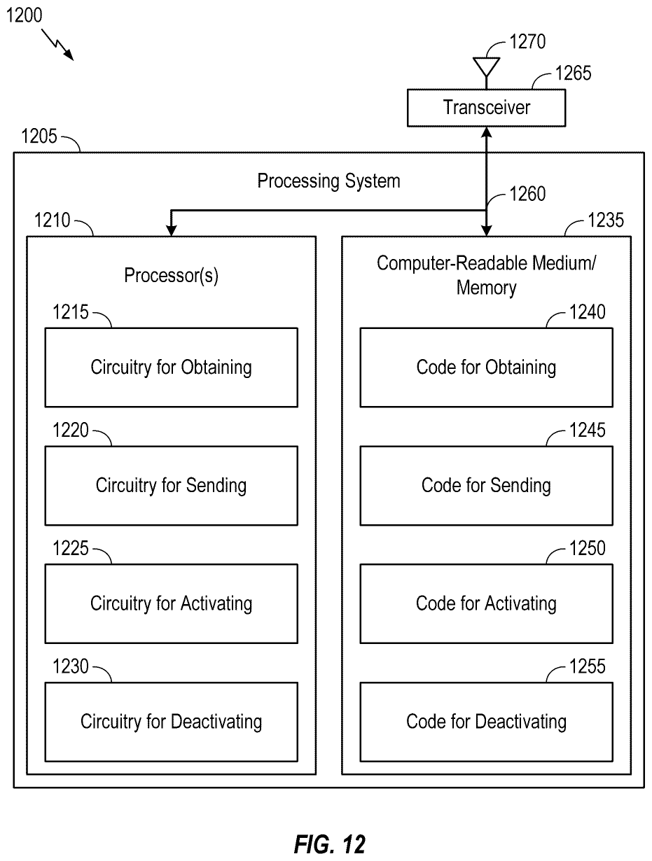

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

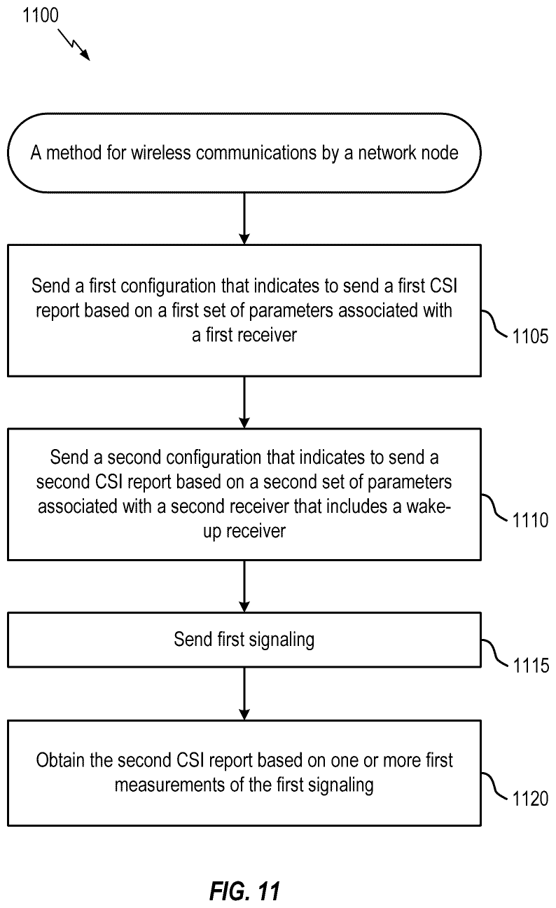

FIG. 11 shows a method 1100 for wireless communications by an apparatus, such as BS 102 of FIG. 1, a first network entity 300 or second network entity 302 of FIG. 3, or a disaggregated base station as discussed with respect to FIG. 2.

Method 1100 begins at block 1105 with sending a first configuration that indicates to send a first CSI report based on a first set of parameters associated with a first receiver, for example, as described herein with respect to FIGS. 7 and 9.

Method 1100 then proceeds to block 1110 with sending a second configuration that indicates to send a second CSI report based on a second set of parameters associated with a second receiver, for example, as described herein with respect to FIGS. 7 and 9.

Method 1100 then proceeds to block 1115 with sending first signaling, as described herein with respect to FIGS. 5 and 9.

Method 1100 then proceeds to block 1120 with obtaining the second CSI report based on one or more first measurements of the first signaling, for example, as described herein with respect to FIGS. 7-9.

In certain aspects, the second set of parameters is different from the first set of parameters.

In certain aspects, the second set of parameters includes one or more of: a rank indicator that is associated with a set of ranks having a total number of ranks less than a rank total of the first set of parameters (a rank indicator that is associated with a set of layers having a total number of layers less than a layer total of the first set of parameters); a channel quality indicator that is associated with a set of modulation and coding scheme indexes having a total number of indexes less than a modulation and coding scheme index total of the first set of parameters; a frequency granularity that is different from a frequency granularity of the first set of parameters; a precoding matrix indicator that is associated with a set of codebooks having a total number of codebooks less than a codebook total of the first set of parameters; an oversampling factor that is different from an oversampling factor of the first set of parameters; a set of CSI reference signal ports having a total number of ports that is less than a port total of the first set of parameters; a set of beams having a total number of beams less than a beam total of the first set of parameters; or a metric having a first quantization granularity that is greater than a second quantization granularity of the first set of parameters.

In certain aspects, the metric includes one or more of a received signal strength or a received signal quality.

In certain aspects, the second set of parameters includes a rank indicator that only indicates a single layer.

In certain aspects, the second set of parameters includes a channel quality indicator that is associated with a set of indexes having a single index per modulation order among a plurality of modulation orders. In certain aspects, the second set of parameters includes a channel quality indicator that is associated with a set of modulation and coding scheme indexes being a subset of indexes associated with the first set of parameters.

In certain aspects, the second set of parameters includes an indication that a single codebook is available to report precoding information. In certain aspects, the second set of parameters includes an indication that a set of codebooks is available to report precoding information, the set of codebooks being a subset of codebooks associated with the first set of parameters.

In certain aspects, the second set of parameters includes an indication to report precoding information based on a set of CSI reference signal ports having a total number of ports that is less than or equal to eight CSI reference signal ports. In certain aspects, the second set of parameters includes an indication to report precoding information based on a set of CSI reference signal ports having a total number of ports that is less than or equal to a total number of CSI reference signal ports (e.g., 32 CSI-RS ports) associated with the first set of parameters.

In certain aspects, the second set of parameters includes an indication to report precoding information with only one of a wideband frequency granularity or a subband frequency granularity.

In certain aspects, the second set of parameters includes an indication to report precoding information with a wideband frequency granularity and a single-subband frequency granularity.

In certain aspects, the second set of parameters includes an indication to report precoding information associated with a set of beams having a total number of beams less than a beam total of the first set of parameters.

In certain aspects, the first set of parameters includes an indication of a first periodicity to send the first CSI report; the second set of parameters includes an indication of a second periodicity to send the second CSI report; and the second periodicity is greater than the first periodicity.

In certain aspects, the second periodicity is based on the first periodicity.

In certain aspects, method 1100 further includes obtaining an acknowledgement of the second set of parameters.

In certain aspects, method 1100 further includes obtaining a request for usage of the second set of parameters, wherein block 1110 includes sending the second configuration after communication of the request.

In certain aspects, the second configuration further indicates that the second set of parameters apply outside an active time associated with a discontinuous reception cycle.

In certain aspects, the second configuration further indicates that the second set of parameters apply within the active time.

In certain aspects, the second configuration further indicates that the second set of parameters apply to a discontinuous reception cycle.

In certain aspects, method 1100 further includes sending second signaling.

In certain aspects, method 1100 further includes obtaining the first CSI report based on one or more second measurements of the second signaling, wherein the first signaling occupies a frequency bandwidth that is less than a bandwidth of the second signaling.

In certain aspects, method 1100 further includes obtaining an indication that reception of the first signaling was via the first receiver.

In certain aspects, method 1100 further includes sending an indication to activate the second configuration.

In certain aspects, method 1100 further includes sending an indication to deactivate the second configuration.

In certain aspects, the first signaling comprises one or more of a CSI reference signal, a synchronization signal, or a tracking reference signal.

In certain aspects, the method 1100 further includes sending at least one of: an indication that activation of the second configuration depends on an entry condition being satisfied, or an indication that deactivation of the second configuration depends on an exit condition being satisfied. In certain aspects, the entry condition is associated with first synchronization signaling; and the exit condition is associated with second synchronization signaling.

In certain aspects, method 1100 further includes sending an indication that activation of the second configuration depends on the second receiver being enabled. In certain aspects, method 1100 further includes sending an indication that deactivation of the second configuration depends on the second receiver being disabled.

In certain aspects, the first receiver is different from the second receiver.

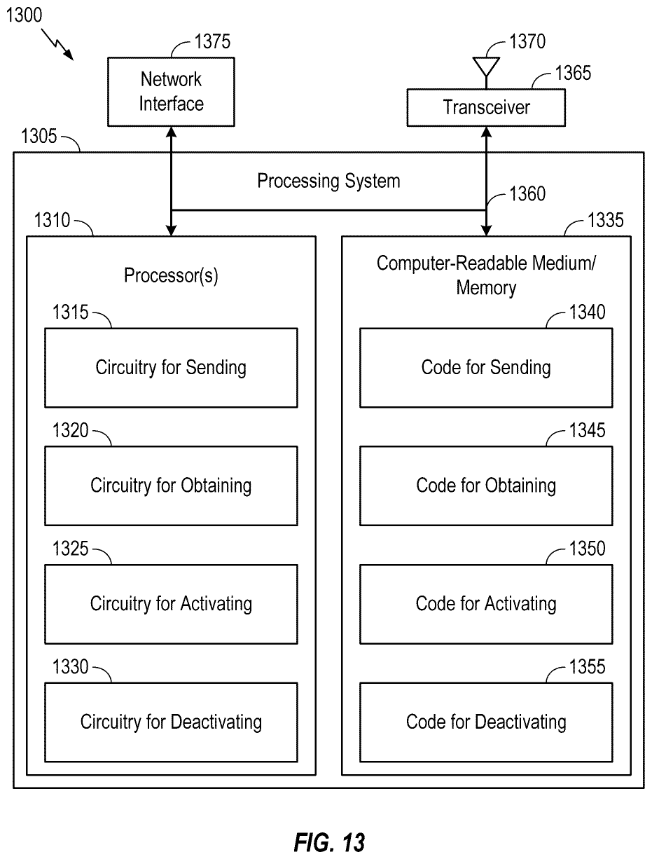

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In certain aspects, communications device 1200 is a user equipment, such as UE 104 described above with respect to FIG. 1 or UE 304 described with respect to FIG. 3.

The communications device 1200 includes a processing system 1205 coupled to a transceiver 1265 (e.g., a transmitter and/or a receiver). The transceiver 1265 is configured to transmit and receive signals for the communications device 1200 via an antenna 1270, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1235. In various aspects, the one or more processors 1210 may be representative of the one or more processors 318 described with respect to FIG. 3. The one or more processors 1210 are coupled to a computer-readable medium/memory 1235 via a bus 1260. In certain aspects, the computer-readable medium/memory 1235 may be representative of the one or more memories 320 described with respect to FIG. 3. The computer-readable medium/memory 1235 is a non-transitory computer-readable medium/memory. In certain aspects, the computer-readable medium/memory 1235 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1235 stores code (e.g., executable instructions), including code for obtaining 1240, code for sending 1245, code for activating 1250, and code for deactivating 1255. Processing of the code 1240-1255 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry for obtaining 1215, circuitry for sending 1220, circuitry for activating 1225, and circuitry for deactivating 1230. Processing with circuitry 1215-1230 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12. For example, means for activating and/or means for deactivating of the method 1000 described with respect to FIG. 10, or any aspect related to it, may include processing system 316 of the UE 304 illustrated in FIG. 3, and/or one or more processors 1210 of the communications device 1200 in FIG. 12

FIG. 13 depicts aspects of an example communications device configured for wireless communications. In certain aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, one or more processors 1310 may be representative of the one or more processors 308, as described with respect to FIG. 3. The one or more processors 1310 are coupled to the computer-readable medium/memory 1335 via a bus 1360. In certain aspects, the computer-readable medium/memory 1335 is configured to store instructions (e.g., computer-executable code), including code 1340-1355, that when executed by the one or more processors 1310, cause the one or more processors 1310 to perform the method 1100 described with respect to FIG. 11, or any aspect related to it, including any operations described in relation to FIG. 11. The computer-readable medium/memory 1335 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1335 stores code (e.g., executable instructions), including code for sending 1340, code for obtaining 1345, code for activating 1350, and code for deactivating 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for sending 1315, circuitry for obtaining 1320, circuitry for activating 1325, and circuitry for deactivating 1330. Processing with circuitry 1315-1330 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. For example, means for activating and/or means for deactivating of the method 1100 described with respect to FIG. 11, or any aspect related to it, may include processing system 306 of the first network entity 300 or the second network entity 302 illustrated in FIG. 3, and/or one or more processors 1310 of the communications device 1300 in FIG. 13.

### Example Clauses

Implementation examples are described in the following numbered clauses:

Clause 1: A method for wireless communications by a UE comprising: obtaining a first configuration that indicates to send a first CSI report based on a first set of parameters associated with a first receiver; obtaining a second configuration that indicates to send a second CSI report based on a second set of parameters associated with a second receiver that includes a wake-up receiver; obtaining first signaling; and sending the second CSI report based on one or more first measurements of the first signaling.

Clause 2: The method of Clause 1, wherein the second set of parameters is different from the first set of parameters.

Clause 3: The method of Clause 2, wherein the second set of parameters includes one or more of: a rank indicator that is associated with a set of layers having a total number of layers less than a layer total of the first set of parameters; a channel quality indicator that is associated with a set of modulation and coding scheme indexes having a total number of indexes less than a modulation and coding scheme index total of the first set of parameters; a frequency granularity that is different from a frequency granularity of the first set of parameters; a precoding matrix indicator that is associated with a set of codebooks having a total number of codebooks less than a codebook total of the first set of parameters; an oversampling factor that is different from an oversampling factor of the first set of parameters; a set of CSI reference signal ports having a total number of ports that is less than a port total of the first set of parameters; a set of beams having a total number of beams less than a beam total of the first set of parameters; or a metric having a first quantization granularity that is greater than a second quantization granularity of the first set of parameters.

Clause 4: The method of Clause 3, wherein the metric includes one or more of a received signal strength or a received signal quality.

Clause 5: The method of Clause 2 or 4, wherein the second set of parameters includes a rank indicator that only indicates a single layer.

Clause 6: The method according to any of Clauses 2-5, wherein the second set of parameters includes a channel quality indicator that is associated with a set of modulation and coding scheme indexes being a subset of indexes associated with the first set of parameters.

Clause 7: The method according to any of Clauses 2-6, wherein the second set of parameters includes an indication that a set of codebooks is available to report precoding information, the set of codebooks being a subset of codebooks associated with the first set of parameters.

Clause 8: The method according to any of Clauses 2-7, wherein the second set of parameters includes an indication to report precoding information based on a set of CSI reference signal ports having a total number of ports that is less than or equal to a total number of CSI reference signal ports associated with the first set of parameters.

Clause 9: The method according to any of Clauses 2-8, wherein the second set of parameters includes an indication to report precoding information with only one of a wideband frequency granularity or a subband frequency granularity.

Clause 10: The method according to any of Clauses 2-9, wherein the second set of parameters includes an indication to report precoding information with a wideband frequency granularity and a single-subband frequency granularity.

Clause 11: The method according to any of Clauses 2-10, wherein the second set of parameters includes an indication to report precoding information associated with a set of beams having a total number of beams less than a beam total of the first set of parameters.

Clause 12: The method according to any of Clauses 2-11, wherein: the first set of parameters includes an indication of a first periodicity to send the first CSI report; the second set of parameters includes an indication of a second periodicity to send the second CSI report; and the second periodicity is greater than the first periodicity.

Clause 13: The method of Clause 12, wherein the second periodicity is based on the first periodicity.

Clause 14: The method of any of Clauses 1-13, further comprising: sending an acknowledgement of the second set of parameters.

Clause 15: The method of any of Clauses 1-14, further comprising: sending a request for usage of the second set of parameters, wherein obtaining the second configuration comprises obtaining the second configuration after communication of the request.

Clause 16: The method of any of Clauses 1-15, wherein the second configuration further indicates that the second set of parameters apply outside an active time associated with a discontinuous reception cycle.

Clause 17: The method of Clause 16, wherein the second configuration further indicates that the second set of parameters apply within the active time.

Clause 18: The method of any of Clauses 1-17, wherein the second configuration further indicates that the second set of parameters apply to a discontinuous reception cycle.

Clause 19: The method of any of Clauses 1-18, further comprising: obtaining second signaling; and sending the first CSI report based on one or more second measurements of the second signaling, wherein the first signaling occupies a frequency bandwidth that is less than a bandwidth of the second signaling.

Clause 20: The method of any of Clauses 1-19, wherein obtaining the first signaling comprises obtaining the first signaling via the second receiver.

Clause 21: The method of any of Clauses 1-20, wherein obtaining the first signaling comprises obtaining the first signaling via the first receiver.

Clause 22: The method of Clause 21, further comprising: sending an indication that reception of the first signaling was via the first receiver.

Clause 23: The method of any of Clauses 1-22, further comprising: obtaining an indication to activate the second configuration.

Clause 24: The method of any of Clauses 1-23, further comprising: obtaining an indication to deactivate the second configuration.

Clause 25: The method of any of Clauses 1-24, wherein the first signaling comprises one or more of a CSI reference signal, a synchronization signal, or a tracking reference signal.

Clause 26: The method of any of Clauses 1-25, wherein further comprising obtaining at least one of: an indication that activation of the second configuration depends on an entry condition being satisfied, or an indication that deactivation of the second configuration depends on an exit condition being satisfied; and obtaining second signaling, in accordance with the first configuration, based on the exit condition being satisfied; wherein obtaining the first signaling comprises obtaining the first signaling, in accordance with the second configuration, based on the entry condition being satisfied.

Clause 27: The method of Clause 26, wherein: the entry condition is associated with first synchronization signaling; and the exit condition is associated with second synchronization signaling.

Clause 28: The method of any of Clauses 1-27, further comprising: obtaining an indication that activation of the second configuration depends on the second receiver being enabled; obtaining an indication that deactivation of the second configuration depends on the second receiver being disabled; obtaining second signaling, in accordance with the first configuration, based on the second receiver being disabled; wherein obtaining the first signaling comprises obtaining the first signaling, in accordance with the second configuration, based on the second receiver being enabled.

Clause 29: The method of any of Clauses 1-28, wherein the first receiver is different from the second receiver.

Clause 30: A method for wireless communications by a network node comprising: sending a first configuration that indicates to send a first CSI report based on a first set of parameters associated with a first receiver; sending a second configuration that indicates to send a second CSI report based on a second set of parameters associated with a second receiver that includes a wake-up receiver; sending first signaling; and obtaining the second CSI report based on one or more first measurements of the first signaling.

Clause 31: The method of Clause 30, wherein the second set of parameters is different from the first set of parameters.

Clause 32: The method of Clause 31, wherein the second set of parameters includes one or more of: a rank indicator that is associated with a set of layers having a total number of layers less than a layer total of the first set of parameters; a channel quality indicator that is associated with a set of modulation and coding scheme indexes having a total number of indexes less than a modulation and coding scheme index total of the first set of parameters; a frequency granularity that is different from a frequency granularity of the first set of parameters; a precoding matrix indicator that is associated with a set of codebooks having a total number of codebooks less than a codebook total of the first set of parameters; an oversampling factor that is different from an oversampling factor of the first set of parameters; a set of CSI reference signal ports having a total number of ports that is less than a port total of the first set of parameters; a set of beams having a total number of beams less than a beam total of the first set of parameters; or a metric having a first quantization granularity that is greater than a second quantization granularity of the first set of parameters.

Clause 33: The method of Clause 32, wherein the metric includes one or more of a received signal strength or a received signal quality.

Clause 34: The method of Clause 31 or 33, wherein the second set of parameters includes a rank indicator that only indicates a single layer.

Clause 35: The method according to any of Clauses 31-34, wherein the second set of parameters includes a channel quality indicator that is associated with a set of modulation and coding scheme indexes being a subset of indexes associated with the first set of parameters.

Clause 36: The method according to any of Clauses 31-35, wherein the second set of parameters includes an indication that a set of codebooks is available to report precoding information, the set of codebooks being a subset of codebooks associated with the first set of parameters.

Clause 37: The method according to any of Clauses 31-36, wherein the second set of parameters includes an indication to report precoding information based on a set of CSI reference signal ports having a total number of ports that is less than or equal to a total number of CSI reference signal ports associated with the first set of parameters.

Clause 38: The method according to any of Clauses 31-37, wherein the second set of parameters includes an indication to report precoding information with only one of a wideband frequency granularity or a subband frequency granularity.

Clause 39: The method according to any of Clauses 31-38, wherein the second set of parameters includes an indication to report precoding information with a wideband frequency granularity and a single-subband frequency granularity.

Clause 40: The method according to any of Clauses 31-39, wherein the second set of parameters includes an indication to report precoding information associated with a set of beams having a total number of beams less than a beam total of the first set of parameters.

Clause 41: The method according to any of Clauses 31-40, wherein: the first set of parameters includes an indication of a first periodicity to send the first CSI report; the second set of parameters includes an indication of a second periodicity to send the second CSI report; and the second periodicity is greater than the first periodicity.

Clause 42: The method of Clause 41, wherein the second periodicity is based on the first periodicity.

Clause 43: The method of any of Clauses 30-42, further comprising: obtaining an acknowledgement of the second set of parameters.

Clause 44: The method of any of Clauses 30-43, further comprising: obtaining a request for usage of the second set of parameters, wherein sending the second configuration comprises sending the second configuration after communication of the request.

Clause 45: The method of any of Clauses 30-44, wherein the second configuration further indicates that the second set of parameters apply outside an active time associated with a discontinuous reception cycle.

Clause 46: The method of Clause 45, wherein the second configuration further indicates that the second set of parameters apply within the active time.

Clause 47: The method of any of Clauses 30-46, wherein the second configuration further indicates that the second set of parameters apply to a discontinuous reception cycle.

Clause 48: The method of any of Clauses 30-47, further comprising: sending second signaling; and obtaining the first CSI report based on one or more second measurements of the second signaling, wherein the first signaling occupies a frequency bandwidth that is less than a bandwidth of the second signaling.

Clause 49: The method of any of Clauses 30-48, further comprising: obtaining an indication that reception of the first signaling was via the first receiver.

Clause 50: The method of any of Clauses 30-49, further comprising: sending an indication to activate the second configuration.

Clause 51: The method of any of Clauses 30-50, further comprising: sending an indication to deactivate the second configuration.

Clause 52: The method of any of Clauses 30-51, wherein the first signaling comprises one or more of a CSI reference signal, a synchronization signal, or a tracking reference signal.

Clause 53: The method of any of Clauses 30-52, further comprising sending at least one of: an indication that activation of the second configuration depends on an entry condition being satisfied, or an indication that deactivation of the second configuration depends on an exit condition being satisfied.

Clause 54: The method of Clause 53, wherein: the entry condition is associated with first synchronization signaling; and the exit condition is associated with second synchronization signaling.

Clause 55: The method of any of Clauses 30-54, further comprising: sending an indication that activation of the second configuration depends on the second receiver being enabled; and sending an indication that deactivation of the second configuration depends on the second receiver being disabled.

Clause 56: The method of any of Clauses 30-55, wherein the first receiver is different from the second receiver.

Clause 57: One or more apparatuses, comprising: one or more memories comprising executable instructions; and one or more processors configured to execute the executable instructions and cause the one or more apparatuses to perform a method in accordance with any of Clauses 1-56.

Clause 58: One or more apparatuses configured for wireless communications, comprising: one or more memories; and one or more processors, coupled to the one or more memories, configured to cause the one or more apparatuses to perform a method in accordance with any of Clauses 1-56.

Clause 59: One or more apparatuses configured for wireless communications, comprising: one or more memories; and one or more processors, coupled to the one or more memories, configured to perform a method in accordance with any of Clauses 1-56.

Clause 60: One or more apparatuses, comprising means for performing a method in accordance with any of Clauses 1-56.

Clause 61: One or more non-transitory computer-readable media comprising executable instructions that, when executed by one or more processors of one or more apparatuses, cause the one or more apparatuses to perform a method in accordance with any of Clauses 1-56.

Clause 62: One or more computer program products embodied on one or more computer-readable storage media comprising code for performing a method in accordance with any of Clauses 1-56.

Clause 63: One or more apparatuses configured for wireless communications, comprising: a processing system that includes one or more processors and one or more memories coupled with the one or more processors, the processing system configured to cause the one or more apparatuses to perform a method in accordance with any of Clauses 1-56.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain a first configuration that indicates to send a first channel state information (CSI) report based on a first set of parameters associated with a first receiver;
obtain a second configuration that indicates to send a second CSI report based on a second set of parameters associated with a second receiver that includes a wake-up receiver;
obtain first signaling; and
send the second CSI report based on one or more first measurements of the first signaling.

2. The apparatus of claim 1, wherein the second set of parameters is different from the first set of parameters.

3. The apparatus of claim 2, wherein the second set of parameters includes one or more of:
a rank indicator that is associated with a set of layers having a total number of layers less than a layer total of the first set of parameters;
a channel quality indicator that is associated with a set of modulation and coding scheme indexes having a total number of indexes less than a modulation and coding scheme index total of the first set of parameters;
a frequency granularity that is different from a frequency granularity of the first set of parameters;
a precoding matrix indicator that is associated with a set of codebooks having a total number of codebooks less than a codebook total of the first set of parameters;
an oversampling factor that is different from an oversampling factor of the first set of parameters;
a set of CSI reference signal ports having a total number of ports that is less than a port total of the first set of parameters;
a set of beams having a total number of beams less than a beam total of the first set of parameters; or
a metric having a first quantization granularity that is greater than a second quantization granularity of the first set of parameters.

4. The apparatus of claim 3, wherein the metric includes one or more of a received signal strength or a received signal quality.

5. The apparatus of claim 2, wherein the second set of parameters includes a rank indicator that only indicates a single layer.

6. The apparatus of claim 2, wherein the second set of parameters includes a channel quality indicator that is associated with a set of modulation and coding scheme indexes being a subset of indexes associated with the first set of parameters.

7. The apparatus of claim 2, wherein the second set of parameters includes an indication that a set of codebooks is available to report precoding information, the set of codebooks being a subset of codebooks associated with the first set of parameters.

8. The apparatus of claim 2, wherein the second set of parameters includes an indication to report precoding information based on a set of CSI reference signal ports having a total number of ports that is less than or equal to a total number of CSI reference signal ports associated with the first set of parameters.

9. The apparatus of claim 2, wherein the second set of parameters includes an indication to report precoding information with only one of a wideband frequency granularity or a subband frequency granularity.

10. The apparatus of claim 2, wherein the second set of parameters includes an indication to report precoding information with a wideband frequency granularity and a single-subband frequency granularity.

11. The apparatus of claim 2, wherein the second set of parameters includes an indication to report precoding information associated with a set of beams having a total number of beams less than a beam total of the first set of parameters.

12. The apparatus of claim 2, wherein:
the first set of parameters includes an indication of a first periodicity to send the first CSI report;
the second set of parameters includes an indication of a second periodicity to send the second CSI report; and
the second periodicity is greater than the first periodicity.

13. The apparatus of claim 12, wherein the second periodicity is based on the first periodicity.

14. The apparatus of claim 1, wherein:
the processing system is configured to cause the UE to obtain at least one of:
an indication that activation of the second configuration depends on an entry condition being satisfied, or
an indication that deactivation of the second configuration depends on an exit condition being satisfied;
to cause the UE to obtain the first signaling, the processing system is configured to cause the UE to obtain the first signaling, in accordance with the second configuration, based on the entry condition being satisfied; and
the processing system is configured to cause the UE to obtain second signaling, in accordance with the first configuration, based on the exit condition being satisfied.

15. The apparatus of claim 14, wherein:
the entry condition is associated with first synchronization signaling; and
the exit condition is associated with second synchronization signaling.

16. The apparatus of claim 1, wherein:
the processing system is configured to cause the UE to:
obtain an indication that activation of the second configuration depends on the second receiver being enabled; and
obtain an indication that deactivation of the second configuration depends on the second receiver being disabled;
to cause the UE to obtain the first signaling, the processing system is configured to cause the UE to obtain the first signaling, in accordance with the second configuration, based on the second receiver being enabled; and
the processing system is configured to cause the UE to obtain second signaling, in accordance with the first configuration, based on the second receiver being disabled.

17. The apparatus of claim 1, wherein the first receiver is different from the second receiver.

18. An apparatus for wireless communications, comprising a processing system that includes one or more processors and one or more memories coupled with the one or more processors, the processing system configured to cause a network node to:
send a first configuration that indicates to send a first channel state information (CSI) report based on a first set of parameters associated with a first receiver;
send a second configuration that indicates to send a second CSI report based on a second set of parameters associated with a second receiver that includes a wake-up receiver;
send first signaling; and
obtain the second CSI report based on one or more first measurements of the first signaling.

19. The apparatus of claim 18, wherein the second set of parameters is different from the first set of parameters.

20. The apparatus of claim 19, wherein the second set of parameters includes one or more of:
a rank indicator that is associated with a set of layers having a total number of layers less than a layer total of the first set of parameters;
a channel quality indicator that is associated with a set of modulation and coding scheme indexes having a total number of indexes less than a modulation and coding scheme index total of the first set of parameters;
a frequency granularity that is different from a frequency granularity of the first set of parameters;
a precoding matrix indicator that is associated with a set of codebooks having a total number of codebooks less than a codebook total of the first set of parameters;
an oversampling factor that is different from an oversampling factor of the first set of parameters;
a set of CSI reference signal ports having a total number of ports that is less than a port total of the first set of parameters;
a set of beams having a total number of beams less than a beam total of the first set of parameters; or
a metric having a first quantization granularity that is greater than a second quantization granularity of the first set of parameters.

21. The apparatus of claim 19, wherein the second set of parameters includes a rank indicator that only indicates a single layer.

22. The apparatus of claim 19, wherein the second set of parameters includes a channel quality indicator that is associated with a set of modulation and coding scheme indexes being a subset of indexes associated with the first set of parameters.

23. The apparatus of claim 19, wherein the second set of parameters includes an indication that a set of codebooks is available to report precoding information, the set of codebooks being a subset of codebooks associated with the first set of parameters.

24. The apparatus of claim 19, wherein the second set of parameters includes an indication to report precoding information based on a set of CSI reference signal ports having a total number of ports that is less than or equal to a total number of CSI reference signal ports associated with the first set of parameters.

25. The apparatus of claim 19, wherein the second set of parameters includes an indication to report precoding information with only one of a wideband frequency granularity or a subband frequency granularity.

26. The apparatus of claim 19, wherein the second set of parameters includes an indication to report precoding information with a wideband frequency granularity and a single-subband frequency granularity.

27. The apparatus of claim 19, wherein the second set of parameters includes an indication to report precoding information associated with a set of beams having a total number of beams less than a beam total of the first set of parameters.

28. The apparatus of claim 19, wherein:
the first set of parameters includes an indication of a first periodicity to send the first CSI report;
the second set of parameters includes an indication of a second periodicity to send the second CSI report; and
the second periodicity is greater than the first periodicity.

29. A method for wireless communications by a user equipment (UE), comprising:
obtaining a first configuration that indicates to send a first channel state information (CSI) report based on a first set of parameters associated with a first receiver;
obtaining a second configuration that indicates to send a second CSI report based on a second set of parameters associated with a second receiver that includes a wake-up receiver;
obtaining first signaling; and
sending the second CSI report based on one or more first measurements of the first signaling.

30. A method for wireless communications by a network node, comprising:
sending a first configuration that indicates to send a first channel state information (CSI) report based on a first set of parameters associated with a first receiver;
sending a second configuration that indicates to send a second CSI report based on a second set of parameters associated with a second receiver that includes a wake-up receiver;
sending first signaling; and
obtaining the second CSI report based on one or more first measurements of the first signaling.
